(19) United States
(12) Patent Application Publication
(10) Pub. No.: US 2026/0141523 A1
(43) Pub. Date: May 21, 2026

(54) SYSTEMS AND METHODS FOR AGRICULTURAL PRODUCE ASSESSMENT

(71) Applicant: Dragonfly Information Technology Inc., Kingston (CA)

(72) Inventor: Matthew Deir, Kingston (CA)

(21) Appl. No.: 19/388,539

(22) Filed: Nov. 13, 2025

Related U.S. Application Data
(60) Provisional application No. 63/721,297, filed on Nov. 15, 2024.

(51) Int. Cl. G06T 7/00; G01S 17/89; G06T 7/10; G06T 7/73; G06T 15/06; G06V 10/26; G06V 20/10

(52) U.S. Cl. CPC G06T 7/0014; G01S 17/89; G06T 7/10; G06T 7/73; G06T 15/06; G06V 10/26; G06V 20/188; G06T 2207/30188; G06V 2201/10

(57) ABSTRACT

An agricultural produce assessment system has a memory configured to store one or more AI models; and a processor coupled to the memory. The processor is configured to: receive one or more images captured by a mobile device; segment at least one produce object in the one or more images using the one or more AI models; determine a 3D position of the at least one produce object by ray casting from an image position of the at least one produce object to a 3D mesh, wherein the 3D mesh is generated by the mobile device based on relative position data of the mobile device with reference to the at least one produce object; and generate an assessment output by tracking the at least one produce object in the one or more images based on the determined 3D position.

### CROSS-REFERENCE TO RELATED APPLICATION

This application claims the benefit of U.S. Provisional Ser. No. 63/721,297 filed Nov. 15, 2024, and the entire content of United States Provisional Ser. No. 63/721,297 is incorporated by reference herein.

### FIELD

Various embodiments are described herein that generally relate to computer vision and in particular to computer vision applications for agricultural produce assessment.

### BACKGROUND

The following paragraphs are provided by way of background to the present disclosure. They are not however an admission that anything discussed therein is prior art or part of the knowledge of a person of skill in the art.

Computer vision involves automated extraction, analysis, and understanding of useful information from a single image or a sequence of images. Computer vision applications can enable automated assessment of agricultural produce. The agricultural produce may include any suitable crops including commercially grown fruits and vegetables.

Agricultural produce assessments may be performed for pre-harvest and/or harvested produce. The assessment may be used for various agricultural management decisions. For example, a pre-harvest assessment may be used to provide crop yield predictions. As another example, a pre-harvest assessment may enable staging of equipment and resources for harvesting the produce. As another example, a post-harvest assessment may be used to allocate packaging and/or storage equipment and resources.

However, processing a large number of images for the agricultural produce assessment may require significant computing resources. Further, delays associated with processing the images may reduce agricultural productivity because of delayed decision-making. Accordingly, there is a need for efficient and timely computer vision-based agricultural produce assessment.

### SUMMARY OF VARIOUS EMBODIMENTS

In a broad aspect, in accordance with the teachings herein, there is provided at least one embodiment of an agricultural produce assessment system comprising: a memory configured to store one or more AI models; and a processor coupled to the memory and configured to: receive one or more images captured by a mobile device; segment at least one produce object in the one or more images using the one or more AI models; determine a 3D position of the at least one produce object by ray casting from an image position of the at least one produce object to a 3D mesh, wherein the 3D mesh is generated by the mobile device based on relative position data of the mobile device with reference to the at least one produce object; and generate an assessment output by tracking the at least one produce object in the one or more images based on the determined 3D position.

In at least one embodiment, the relative position data is generated by a Light Detection and Ranging (LiDAR) sensor of the mobile device.

In at least one embodiment, the processor is configured to generate the assessment output by determining a size of the at least one produce object.

In at least one embodiment, a plurality of images captured by the mobile device include the at least one produce object, and the processor is configured to determine the size of the at least one produce object based on multiple size measurements of the at least one produce object using two or more of the plurality of images.

In at least one embodiment, the processor is configured to determine the size by ray casting two or more rays from image coordinates associated with the at least one produce object to the 3D mesh.

In at least one embodiment, determining the image coordinates comprises: using the one or more AI models to determine keypoints indicating an orientation of the at least one produce object; and/or using the one or more AI models to define a bounding box indicating the orientation of the at least one produce object.

In at least one embodiment, the at least one produce object is a fruit and the determined keypoints include keypoints corresponding to a stem or a calyx of the fruit.

In at least one embodiment, the mobile device comprises the processor and the processor is configured to generate the assessment output in real-time and locally on the mobile device.

In at least one embodiment, the processor is further configured to provide a user prompt to capture additional images in response to an occlusion detection of the at least one produce object.

In at least one embodiment, a remote server comprises the processor and the remote server is communicatively coupled with the mobile device.

In at least one embodiment, the agricultural produce assessment is for pre-harvested fruits and/or pre-harvested vegetables.

In at least one embodiment, the agricultural produce assessment is for harvested fruits and/or harvested vegetables.

In at least one embodiment, the processor is configured to segment the at least one produce object by inputting, into the one or more AI models, metadata associated with the one or more images.

In at least one embodiment, the metadata includes image resolution, lighting conditions, and/or context information for the one or more images.

In another aspect, in accordance with the teachings herein, there is provided a computer-implemented method of agricultural produce assessment, the method comprising: receiving, by a processor, one or more images captured by a mobile device; segmenting, by the processor, at least one produce object in the one or more images using the one or more AI models; determining, by the processor, a 3D position of the at least one produce object by ray casting from an image position of the at least one produce object to a 3D mesh, wherein the 3D mesh is generated by the mobile device based on relative position data of the mobile device with reference to the at least one produce object; and generating, by the processor, an assessment output by tracking the at least one produce object in the one or more images based on the determined 3D position.

In at least one embodiment, the relative position data is generated by a Light Detection and Ranging (LiDAR) sensor of the mobile device.

In at least one embodiment, the method comprises generating the assessment output by determining a size of the at least one produce object.

In at least one embodiment, a plurality of images captured by the mobile device include the at least one produce object, and the method further comprises the processor determining the size of the at least one produce object based on multiple size measurements of the at least one produce object using two or more of the plurality of images.

In at least one embodiment, the method comprises the processor determining the size by ray casting two or more rays from image coordinates associated with the at least one produce object to the 3D mesh.

In at least one embodiment, determining the image coordinates comprises: using the one or more AI models to determine keypoints indicating an orientation of the at least one produce object; and/or using the one or more AI models to define a bounding box indicating the orientation of the at least one produce object.

In at least one embodiment, the at least one produce object is a fruit and the determined keypoints include keypoints corresponding to a stem or a calyx of the fruit.

In at least one embodiment, the mobile device comprises the processor and the method comprises the processor generating the assessment output in real-time and locally on the mobile device.

In at least one embodiment, the method further comprises the processor providing a user prompt to capture additional images in response to an occlusion detection of the at least one produce object.

In at least one embodiment, a remote server comprises the processor and the remote server is communicatively coupled with the mobile device.

In at least one embodiment, the agricultural produce assessment is for pre-harvested fruits and/or pre-harvested vegetables.

In at least one embodiment, the agricultural produce assessment is for harvested fruits and/or harvested vegetables.

In at least one embodiment, the method comprises the processor segmenting the at least one produce object by inputting, into the one or more AI models, metadata associated with the one or more images.

In at least one embodiment, the metadata includes image resolution, lighting conditions, and/or context information for the one or more images.

In another aspect, in accordance with the teachings herein, there is provided a non-transitory computer readable medium storing thereon program instructions, which when executed by at least one processor, configure the at least one processor to perform any method of agricultural produce assessment described herein.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1A shows a schematic diagram of an agricultural produce assessment system, according to at least one example embodiment of the teachings provided herein.

FIG. 1B shows a schematic diagram of an agricultural produce assessment system, according to at least one example embodiment of the teachings provided herein.

FIG. 2 shows a block diagram illustrating an example embodiment of the hardware structure of the agricultural produce assessment systems shown in FIGS. 1A and 1B.

FIG. 3 shows a flowchart illustrating a computer-implemented method of agricultural produce assessment, according to at least one example embodiment of the teachings provided herein.

FIG. 4 shows an example captured image, according to at least one example embodiment of the teachings provided herein.

FIG. 5 shows an example captured image, according to at least one example embodiment of the teachings provided herein.

FIG. 6 shows example bounding boxes defined for segmented agricultural produce objects in the example captured image of FIG. 4, according to at least one example embodiment of the teachings provided herein.

FIG. 7 shows example bounding boxes defined for segmented agricultural produce objects in the example captured image of FIG. 5, according to at least one example embodiment of the teachings provided herein.

FIG. 8 shows a schematic diagram of ray casting from an image position associated with a segmented agricultural produce object included in a captured image, according to at least one example embodiment of the teachings provided herein.

FIG. 9 shows a schematic diagram illustrating size determination of a segmented agricultural produce object included in a captured image, according to at least one example embodiment of the teachings provided herein.

FIG. 10 shows schematic diagrams illustrating size determination of a segmented agricultural produce object included in a captured image, according to at least one example embodiment of the teachings provided herein.

FIG. 11 shows determined keypoints and a rotated bounding box defined for an agricultural produce object included in a captured image, according to at least one example embodiment of the teachings provided herein.

FIG. 12A shows an example graphical user interface (GUI) generated based on the example captured image of FIG. 4, according to at least one example embodiment of the teachings provided herein.

FIG. 12B shows an example GUI generated based on the example captured image of FIG. 5, according to at least one example embodiment of the teachings provided herein.

FIG. 13A shows a schematic diagram illustrating a user capturing images of agricultural produce objects, according to at least one example embodiment of the teachings provided herein.

FIG. 13B shows a schematic diagram of an example image that may be captured by the user of FIG. 13A from an initial imaging position, according to at least one example embodiment of the teachings provided herein.

FIG. 13C shows a schematic diagram of an example image that may be captured by the user of FIG. 13A from a new imaging position, according to at least one example embodiment of the teachings provided herein.

Further aspects and features of the example embodiments described herein will appear from the following description taken together with the accompanying drawings.

### DETAILED DESCRIPTION OF THE EMBODIMENTS

The headings and Abstract of the Disclosure provided herein are for convenience only and do not interpret the scope or meaning of the embodiments.

Various embodiments in accordance with the teachings herein will be described below to provide an example of at least one embodiment of the claimed subject matter. No embodiment described herein limits any claimed subject matter. The claimed subject matter is not limited to devices, systems or methods having all of the features of any one of the devices, systems or methods described below or to features common to multiple or all of the devices, systems or methods described herein. It is possible that there may be a device, system or method described herein that is not an embodiment of any claimed subject matter. Any subject matter that is described herein that is not claimed in this document may be the subject matter of another protective instrument, for example, a continuing patent application, and the applicants, inventors or owners do not intend to abandon, disclaim or dedicate to the public any such subject matter by its disclosure in this document.

It will be appreciated that for simplicity and clarity of illustration, where considered appropriate, reference numerals may be repeated among the figures to indicate corresponding or analogous elements. Reference numerals may be composed of a base number followed by an alphabetical or subscript-numerical suffix (e.g. 112a, or 112₁). Multiple elements herein may be identified by part numbers that share a base number in common and that differ by their suffixes (e.g. 112a, 112b, and 112c). All elements with a common base number may be referred to collectively or generically using the base number without a suffix (e.g. 112).

In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling can have a mechanical or electrical connotation. For example, as used herein, the terms coupled or coupling can indicate that two elements or devices can be directly connected to one another or connected to one another through one or more intermediate elements or devices via an electrical signal, electrical connection, or a mechanical element, depending on the particular context.

It should also be noted that, as used herein, the wording “and/or” is intended to represent an inclusive-or. That is, “X and/or Y” is intended to mean X or Y or both X and Y, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by ±1%, ±2%, ±5% or ±10%, for example, if this deviation does not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as ±1%, ±2%, ±5%, or ±10%, for example.

In addition, at least a portion of the example embodiments of the systems or methods described in accordance with the teachings herein may be implemented as a combination of hardware or software. For example, a portion of the embodiments described herein may be implemented, at least in part, by using one or more computer programs, executing on one or more programmable devices comprising at least one processing element, and at least one data storage element (including volatile and non-volatile memory). These devices may also have at least one input device (e.g., a touchscreen, and the like) and at least one output device (e.g., a display screen, a printer, a wireless radio, and the like) depending on the nature of the device.

It should also be noted that some elements that are used to implement at least part of the embodiments described herein may be implemented via software that is written in a high-level procedural language such as object-oriented programming. The program code may be written in, for example, JAVA, PYTHON, C, C⁺⁺, Javascript, or in any other suitable programming language and may comprise modules or classes, as is known to those skilled in object-oriented programming. Alternatively, or in addition thereto, some of these elements implemented via software may be written in assembly language, machine language, firmware, or a functional programming language as needed. The functional programming code may be written in, for example, Python, Haskell, Clojure, Lisp, Erlang, or in any other suitable programming language, as is known to those skilled in functional programming.

At least some of the software programs used to implement at least one of the embodiments described herein may be stored on a storage medium (e.g., a computer readable medium such as, but not limited to, ROM, flash memory, magnetic disk, or optical disc) or a device that is readable by a programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions, such as program code, for one or more processors. The program code may be preinstalled and embedded during manufacture and/or may be later installed as an update for an already deployed computing system. The medium may be provided in various forms, including non-transitory forms such as, but not limited to, one or more diskettes, compact disks, DVD, tapes, chips, and magnetic, optical and electronic storage. In alternative embodiments, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

Embodiments disclosed herein generally relate to processing images captured by a mobile device (e.g., a hand-held mobile device) for performing agricultural produce assessments. The agricultural produce may include any suitable crops including commercially grown fruits and/or vegetables. The disclosed embodiments can use one or more AI models to segment produce objects (e.g., fruits and/or vegetables) in the captured images. Further, the disclosed embodiments can determine a 3D position of a segmented produce object by ray casting from an image position of the segmented produce object to a 3D mesh generated by the mobile device. The mobile device can generate the 3D mesh based on relative position data of the mobile device with reference to the produce object.

The disclosed embodiments can perform an assessment by counting the number of segmented produce objects in the captured images. Furthermore, by tracking the segmented produce objects using the 3D mesh, the disclosed embodiments can prevent duplicate assessment of produce objects that are captured in multiple images (e.g., a same fruit may be captured in a series of images during a 360° scan of a tree).

The disclosed embodiments can determine a size of a segmented produce object by ray casting two or more rays from image coordinates associated with the at least one produce object to the 3D mesh. The imaged produce objects may be in various orientations. The disclosed embodiments can provide consistent size measurements irrespective of imaged orientation by using keypoints and/or a bounding box to select image coordinates for ray casting to measure size.

The disclosed embodiments can provide improved accuracy in size determination of segmented produce objects using multiple size measurements. For example, if a produce object is included in multiple captured images, multiple size measurements may be performed for the segmented produce object (e.g., one size measurement for each image that the produce object is included in). Further, a high-accuracy size determination may be made based on the multiple size measurements (e.g., using a statistical measure, such as the mean for example, of the multiple size measurements).

The disclosed embodiments can provide technical advantages compared with conventional methods of agricultural produce assessment where image analysis is conducted using photogrammetry and parallax to create a 3D mesh, and an occlusion model is used to account for occlusions during image capture. Such methods of image analysis can increase computational complexity and require higher computational resources and/or larger processing time. This may prevent the agricultural produce assessment from being conducted in real-time and/or locally on the mobile device.

In contrast, the disclosed embodiments in accordance with the teachings herein can utilize a 3D mesh generated by the mobile device and reduce computational complexity by using ray casting to the 3D mesh to perform the agricultural produce assessment. At least one of the disclosed embodiments can perform the agricultural produce assessment locally on the mobile device without requiring external computing resources (e.g., a remote server that is in network communication with the mobile device). This can enable agricultural produce assessments to be performed locally without relying on a network connection to remote/cloud servers. Additionally, the disclosed embodiments can provide real-time assessment results to a user of the mobile device. In alternative embodiments, captured image data may be sent to a remote server for performing fruit assessment in accordance with the teachings herein.

At least one of the disclosed embodiments can further reduce computational complexity by avoiding the use of occlusion models to conduct assessments for occluded produce objects, which is one way technique used by the embodiments herein to enabling real-time measurement. Instead, at least one of the disclosed embodiments can provide a user prompt to capture additional images in response to detecting occlusion for an imaged produce object. The disclosed embodiments can use any suitable combination of graphical and textual elements to provide the user prompt. In some embodiments, the user prompt may be provided using an augmented reality (AR) display. The AR display can provide directions to a user to move to a new location to capture unoccluded images.

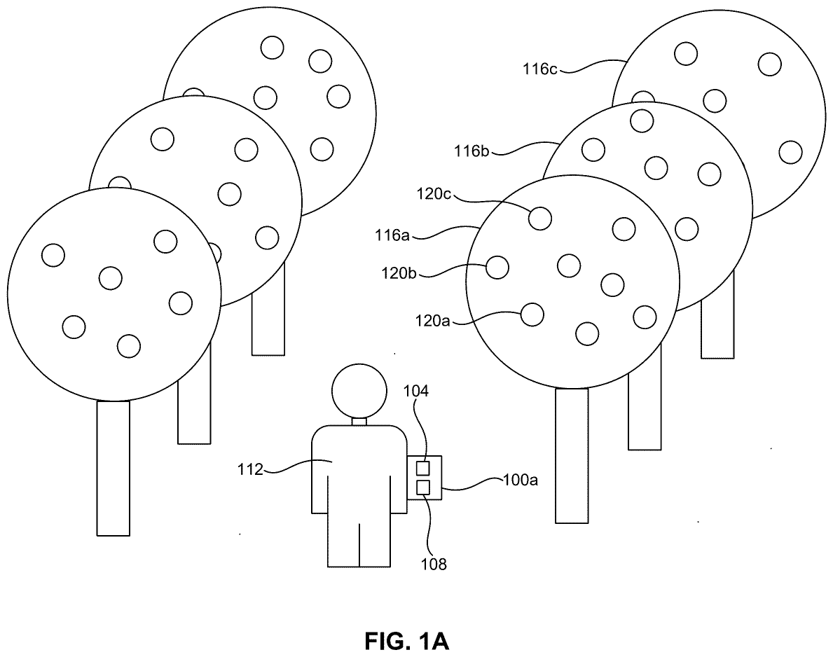

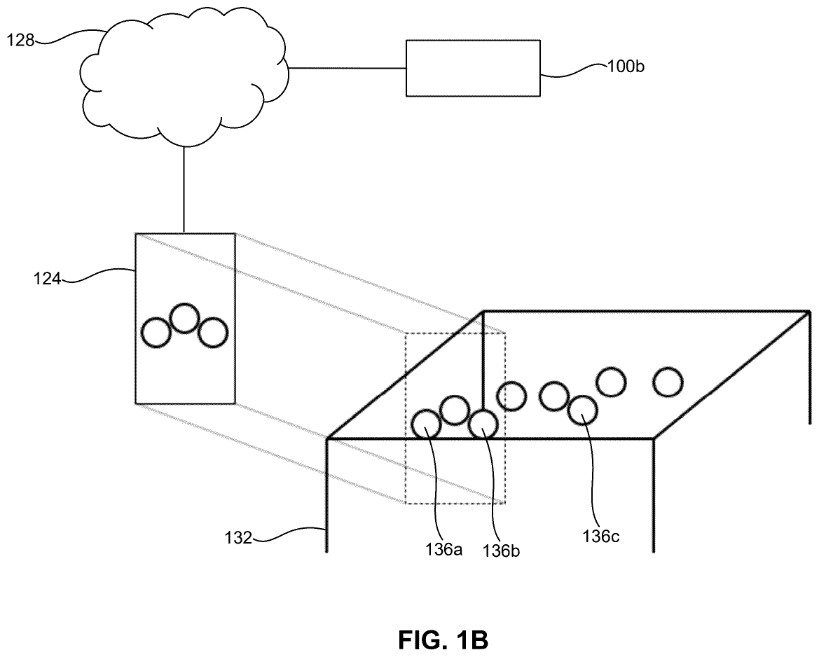

Referring now to FIG. 1A, shown therein is a schematic diagram of a system 100a used for agricultural produce assessment. The agricultural produce may include, for example, fruits and/or vegetables. System 100a may be implemented using any suitable portable computing device such as, but not limited to, a laptop computer, a tablet, a smartphone, a personal digital assistant (PDA), and/or the like. In the illustrated embodiment, system 100a is implemented as a handheld mobile device. In some embodiments, system 100a may be mounted on a mobile platform, for example, a satellite or a vehicle that enables system components to capture image and depth data of agricultural produce objects. The vehicle can include, for example, a terrestrial vehicle and/or an aerial vehicle such as a drone (e.g., a fixed wing drone or any other suitable drone/aircraft). In some embodiments, system 100a may be implemented as a combination of a mobile device in network communication with a remote/cloud server. For example, the mobile device may include components providing image data capture and depth data capture capabilities, and the remote server may include components providing image processing and data storage capabilities. In some embodiments, system 100a may be implemented as a combination of multiple mobile devices (e.g., as a combination of two or more handheld mobile devices) that can share position data and/or image data using any suitable communication network (in real-time or offline). For example, two or more mobile devices may be used to simultaneously capture image data and associated depth data for a tree. This can enable assessment output to be generated at a faster speed. In some embodiments, overlapping captured data may enable improvement in the accuracy of the assessment output.

FIG. 1A shows a user 112 using system 100a for capturing images of pre-harvested fruits 120 (e.g., fruits 120a-120c) on trees 116 (e.g., trees 116a-116c). In the illustrated embodiment, system 100a includes an imaging device 104 to capture image data of fruits 120 and a depth sensor 108 to capture depth data associated with the captured images. Depth sensor 108 may include any suitable sensor for capturing depth data, for example, a Light Detection and Ranging (LiDAR) sensor.

System 100a can process the captured data to generate an assessment output. System 100a can provide, in real-time, the generated assessment output to user 112.

Referring now to FIG. 1B, shown therein is a schematic diagram of a system 100b used for agricultural produce assessment. System 100b may be implemented as a personal computer, desktop computer, a workstation, a server, a portable computer such as a laptop, tablet or smart phone, or a combination of these. In the illustrated embodiment, system 100b is implemented as a remote server that is in network communication with a mobile device 124 via network 128. Mobile device 124 may be implemented as any suitable device or combination of devices configured to capture image data and associated depth data of agricultural produce objects. Mobile device 124 may be a handheld device. In some embodiments, mobile device 124 may include data capture components (e.g., cameras, suitable image sensors) that are mounted on a mobile platform, for example, a satellite or a vehicle. The vehicle can include, for example, a terrestrial vehicle and/or a drone (e.g., a fixed wing drone or any other suitable drone/aircraft). In some embodiments, mobile device 124 may be implemented as a combination of multiple mobile devices (e.g., as a combination of two or more handheld mobile devices) that can share position data and/or image data using any suitable communication network (in real-time or offline) as was described previously.

Network 128 may be any network or network components capable of communicating data including, but not limited to, the Internet, Ethernet, fiber optics, satellite, mobile, wireless (e.g., Wi-Fi, WiMAX), SS7 signaling network, fixed line, local area network (LAN), wide area network (WAN), a direct point-to-point connection, mobile data networks (e.g., Universal Mobile Telecommunications System (UMTS), 3GPP Long-Term Evolution Advanced (LTE Advanced), Worldwide Interoperability for Microwave Access (WiMAX), etc.) and others, including any combination of these.

Mobile device 124 may be any suitable device that can capture image data and associated depth data of harvested fruits 136 (e.g., fruits 136a-136c) in a bin 132. Mobile device can transfer the captured image data to system 100b using network 128.

System 100b can process the captured data, in near real-time or at a delayed time, to generate an assessment output. System 100b can provide the assessment output to mobile device 124 and/or via any suitable user interface.

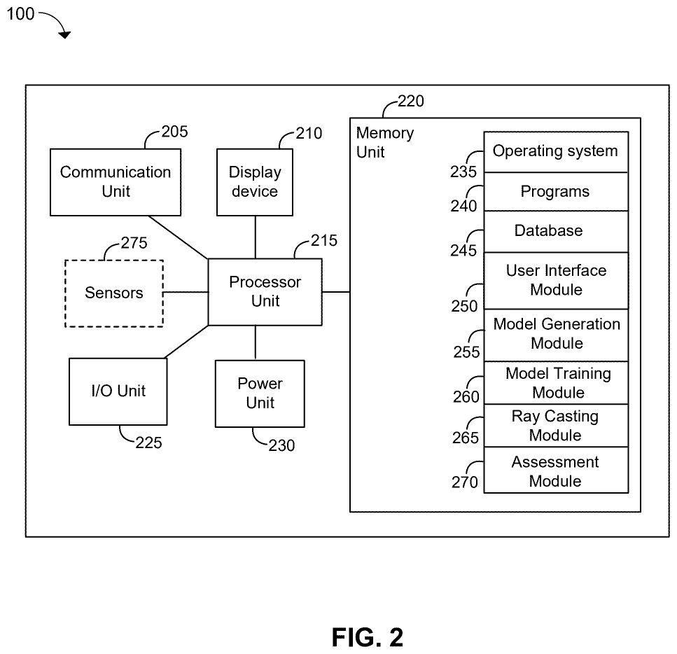

Referring now to FIG. 2, shown therein is a block diagram illustrating an example embodiment of a system 100 which provides an example of the hardware structure of the agricultural produce assessment systems 100a and 100b. In the illustrated example embodiment, system 100 includes a communication unit 205, a display device 210, a processor unit 215, a memory unit 220, an I/O unit 225, and a power unit 230. In some embodiments, system 100 may include sensors 275. For the example system 100a shown in FIG. 1A, sensors 275 includes imaging device 104 and depth sensor 108. In other embodiments, system 100 may include a different combination of components that includes and/or excludes any of the components 205-275.

Communication unit 205 may include wired or wireless connection capabilities. Communication unit 205 may be used by system 100 to communicate with other devices or computers. For example, system 100b (shown in FIG. 1B) may use communication unit 205 to receive captured image data from a mobile device.

Processor unit 215 may control the operation of system 100. Processor unit 215 may include any suitable processor or controller that can provide sufficient processing power depending on the configuration, purposes and requirements of system 100 as is known by those skilled in the art. For example, processor unit 215 may be a high-performance Central Processing Unit (CPU) or Graphics Processing Unit (GPU). For example, processor unit 215 may include an AMD® processor or an Intel® processor. Alternatively, processor unit 215 may include more than one processor with each processor being configured to perform different dedicated tasks. Alternatively, specialized hardware may be used provide some of the functions provided by processor unit 215. For example, specialized hardware like a Nvidia GEForce® video card or a Nvidia RTX® graphics card may be used to provide some of the graphical processing functions provided by processor unit 215.

Display device 210 may be any suitable device that provides a display interface to a user. For example, display device may be a LED or LCD based display. In some embodiments, display device 210 may be a touch sensitive user input device that receives inputs from user contact such as user gestures on the touch sensitive surface of the display device 210. In some embodiments, display device 210 may be integrated into system 100. In other embodiments, display device 210 may be an external device that is communicatively coupled to system 100.

I/O unit 225 may include at least one input device and/or at least one output device. For example, the input device may include a mouse, a keyboard, a touch screen, a thumbwheel, a trackpad, a trackball, a card-reader, voice recognition software and the like, depending on the particular implementation of system 100. The output device may include a speaker, a printer, a scanner and the like. In some embodiments, some of these components may be integrated with one another.

Power unit 230 may be any suitable power source that provides power to system 100 such as a power adaptor or a rechargeable battery pack depending on the implementation of system 100, as is known by those skilled in the art.

Memory unit 220 stores software code for implementing an operating system 235, programs 240, database 245, user interface module 250, model generation module 255, model training module 260, ray casting module 265, and assessment module 270. In other embodiments, the various modules may be organized differently with fewer or more modules being used that collectively provide the same functionality of the modules described herein. The software code may be executed, for example, by processor unit 215. Memory unit 220 may include RAM, ROM, one or more hard drives, one or more flash drives or some other suitable data storage elements such as FLASH drives, etc.

Memory unit 220 can be used to store an operating system 235 and programs 240 as is commonly known by those skilled in the art. For instance, operating system 235 and programs 240 may provide various basic operational processes for system 100. Programs 240 also include programs for executing the functionality of the embodiments described herein. For example, programs 240 may include a program for performing the method 300 and making function calls to the various modules 250 to 270 as needed. Operating system 235 may, for example, be an operating system such as Windows® Server operating system, or Red Hat® Enterprise Linux (RHEL) operating system, or other suitable operating systems known by those skilled in the art.

Database 245 may include a Structured Query Language (SQL) database such as PostgreSQL or MySQL or a not only SQL (NoSQL) database such as MongoDB, or Graph Databases, etc. Database 245 may be integrated with system 100. In some embodiments, database 245 may run independently on a database server in network communication with system 100.

Database 245 may store captured image data and/or associated depth data used for agricultural produce assessments. Database 245 may store one or more AI models used for processing the captured data. In some embodiments, database 245 may store training data used for initial training and/or retraining of the AI models. Database 245 may store generated assessment output data including, for example, count data and size data of assessed agricultural objects. System 100 may use the stored data to generate analytical reports and/or recommended actions.

User interface module 250 includes software instructions that may be executed by the processor unit 215 for generating various user interfaces that may then be displayed on display device 210 and/or on external displays coupled to system 100. The generated user interfaces may include GUIs that provide assessment results including, for example, count and size of agricultural produce objects.

Model generation module 255 includes software instructions that may be executed by the processor unit 215 for generating one or more AI models. The AI models may be implemented using various machine learning algorithms depending on the functionality of the AI models since some machine learning algorithms are better suited than others at performing certain functions. For example, the AI models may include a segmentation model configured for object detection and instance segmentation of agricultural produce objects in captured images. The segmentation model may be based on a convolutional neural network (CNN) architecture, such as Mask Region-based CNN (Mask R-CNN) architecture. In some embodiments, a single segmentation model may be used for different types of agricultural produce objects. In other embodiments, separate segmentation models may be generated and/or trained for different types of agricultural produce objects. Other examples of machine learning algorithms that may be used by system 100 include, but are not limited, to one or more of Pre-Trained Neural Network (PTNN), Transfer Learning, CNN, Deep Neural Networks (DNN), Deep Convolutional Neural Networks (DCNN), Fully Connected Networks (FCN), Recurrent Neural Networks (RNN), Long Term Short Term (LSTM), Transformer Networks, and/or Pyramid Networks for performing certain functions such as, but not limited to, segmenting an agricultural produce object imaged from one or more imaging angles.

In some embodiments, the one or more AI models may include a pose model configured to determine keypoints and/or define a bounding box indicating an orientation of imaged agricultural produce objects. The pose model may be generated based, for example, on a MMPose model, a DeepPoseKit toolkit, an integrated pose model or another suitable model.

In some embodiments, system 100 may not include a model generation module 255. System 100 may receive the one or more AI models from an external device. System 100 may store the generated and/or received models in database 245. In some embodiments, the generated and/or received models may be stored in an external storage device that is communicatively coupled with system 100.

Model training module 260 includes software instructions that may be executed by the processor unit 215 for training one or more AI models. The AI models may be generated by model generation module 255 and/or received from an external device.

Model training module 260 may use any suitable training data based on the AI model being trained and/or the training algorithm being used. The training data may include customized datasets that include different types of fruits, vegetable, trees, vines, shrubs, etc. In some embodiments, model training module 260 may be optional, e.g., when other devices generate and train models which are then sent and saved at system 100 for use.

Model training module 260 may be configured to perform training of the AI models at various times. For example, model training module 260 may be configured to train the models when they are initially generated by model generation module 255. As another example, model training module 260 may be configured to train the models based on a time-based schedule. The time-based schedule may be based on a training period parameter stored in database 245. As another example, model training module 260 may be configured to train the AI models in response to the model output accuracy falling below a threshold level. In some embodiments, model training module 260 may train one or more AI models in response to a training request. The training request may be received, for example, from a user of system 100.

Ray casting module 265 includes software instructions that may be executed by the processor unit 215 for ray casting from a position within a captured image to a 3D mesh to determine a corresponding 3D position. The 3D mesh may be generated by a mobile device associated with system 100 a, 100b using any suitable simultaneous localization and mapping (SLAM) algorithm while capturing the images. Ray casting module 265 can enable system 100 to determine real-world 3D position coordinates (using any suitable reference coordinate system) corresponding to a position within a 2D captured image. In some embodiment, ray casting module 265, or other software instructions, may be used to generate the 3D mesh. For example, the mobile device may be an iPhone® or an iPad® device that uses LiDAR sensor data to generate a 3D point cloud of the environment. Further, the ARKit application programming interface can enable generation of the 3D mesh based on the 3D point cloud.

Assessment module 270 includes software instructions that may be executed by the processor unit 215 for generating an assessment output based on the segmented produce objects and the corresponding 3D positions determined using ray casting module 265. Assessment module 270 may provide the assessment output to a user of system 100 via a user interface generated by user interface module 250. The assessment output may include, for example, a count of produce objects included in a series of captured images. As another example, the assessment output may include a size of each produce object included in a captured image.

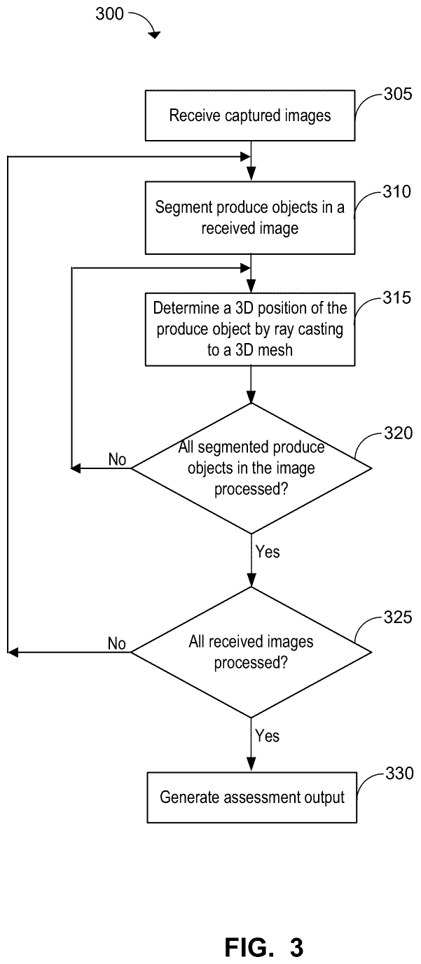

Referring now to FIG. 3, shown therein is a flowchart showing an example embodiment of a computer-implemented process or method 300 of agricultural produce assessment. Method 300 may be performed, for example, by system 100 and concurrent reference is made to components shown in FIGS. 1A, 1B and 2.

While method 300 is primarily described here using example captured images of fruits, the disclosed methods and systems are not limited to fruit assessments and may be used for assessment of any suitable agricultural produce including vegetables.

Method 300 may start automatically (e.g., periodically), manually under a user's command (e.g., in response to input from user 112) and/or when new images are captured/received by system 100.

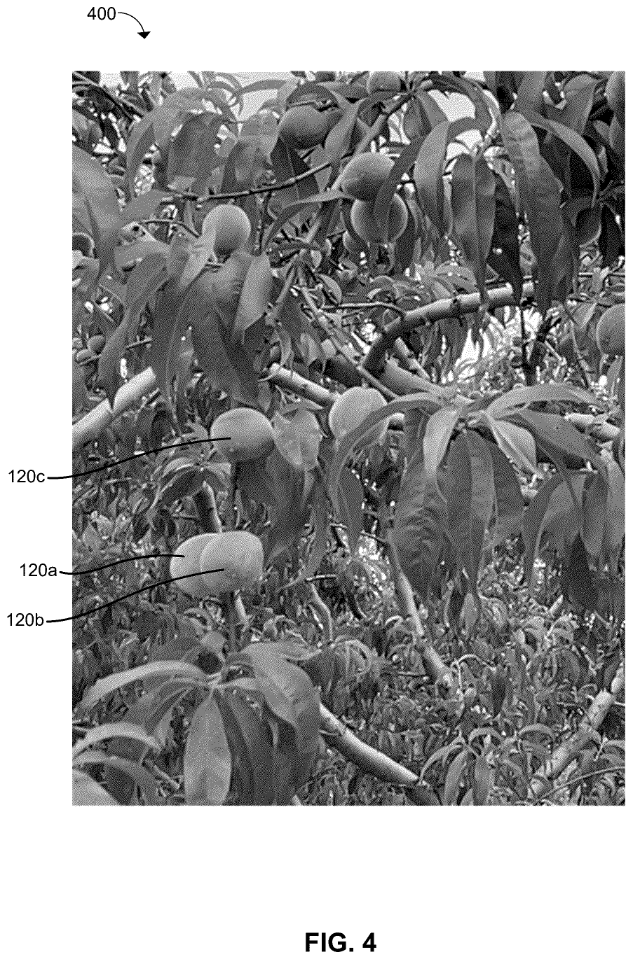

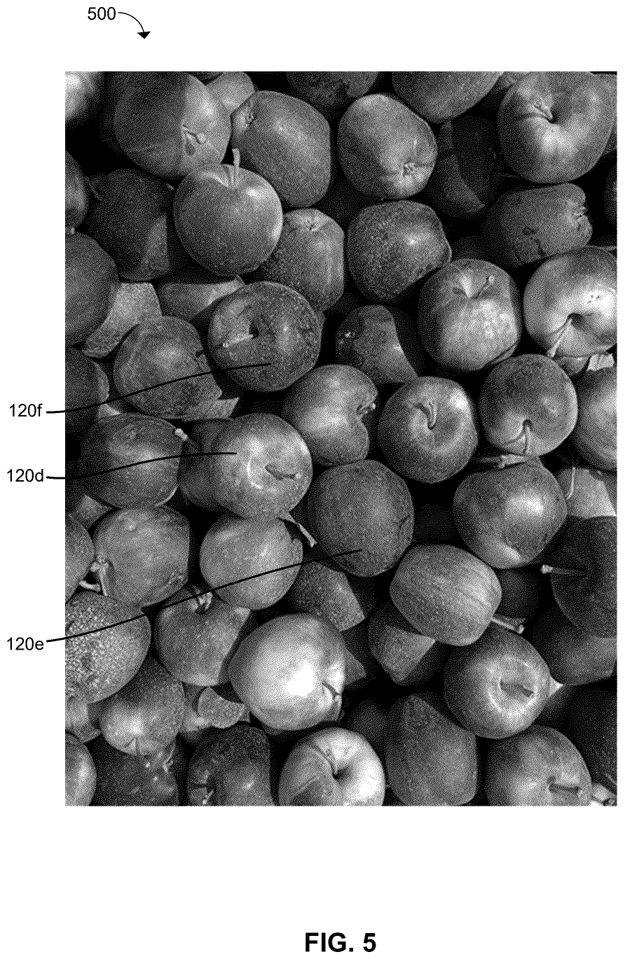

At act 305, processor unit 215 may receive one or more images captured by a mobile device (e.g., system 100a or mobile device 124) for agricultural produce assessment. The received images may include, for example, a series of images of fruit trees 116 captured by a user 112. The series of images may be captured from one or more imaging angles. The series of images may correspond to a full 360° scan of one or more fruit trees and/or a partial scan of one or more fruit trees. FIG. 4 shows an example captured image 400 that includes multiple fruits 120. As another example, the received images may include a series of images of harvested fruits in a bin. FIG. 5 shows an example captured image 500 that includes multiple fruits 120.

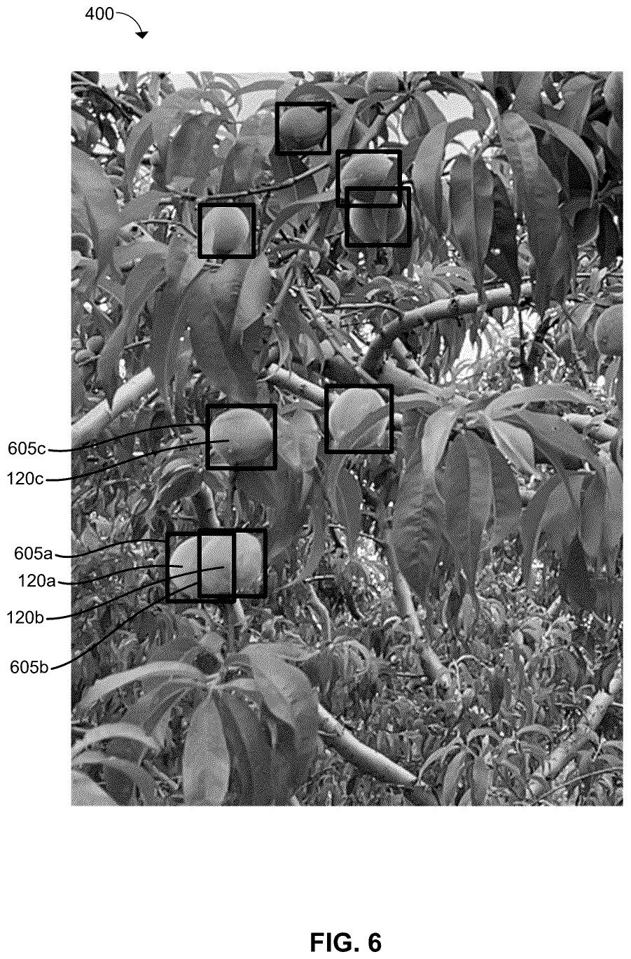

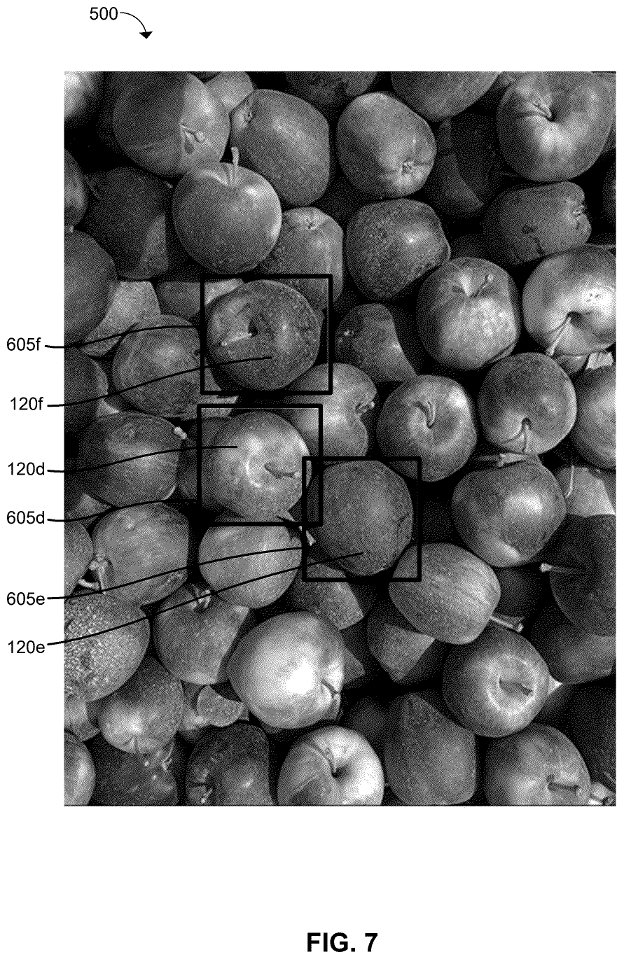

At act 310, processor unit 215 may segment produce objects in each of the received images using one or more AI models. For example, processor unit 215 may use a segmentation model generated by model generation module 255. The segmentation model may generate a mask or bounding box defining detected agricultural objects in a received image. For example, FIG. 6 shows example bounding boxes 605a-605c defined for segmented fruits 120a-120c captured in image 400. As another example, FIG. 7 shows example bounding boxes 605d-605f defined for segmented fruits 120d-120f captured in image 500.

In some embodiments, processor unit 215 may provide metadata associated with the received image to the segmentation model. The input metadata may improve accuracy and/or processing speed of the segmentation model. The metadata may include information such as the image resolution, lighting conditions, and/or context information. For example, the context information in the metadata may include information related to the captured images (e.g., a pre-harvest scan of apple trees, a scan of harvested potatoes in a bin, etc.). As another example, the metadata may include information related to spatial location and timestamps associated with the captured images, which may help contextualize the environment or time-dependent features of the image. Processor unit 215 may input the metadata to the segmentation model in combination with the received image to enable the segmentation model to adjust its image processing accordingly. For example, the metadata may enable the segmentation model to focus on plausible object categories relevant to the image's context (e.g., apples may be relevant, and potatoes may not be relevant when captured images are for a pre-harvest scan of apple trees).

Processor unit 215 may use image position data (e.g., pixel coordinates) of the segmented produce object to determine a 3D position of the imaged produce object. In some embodiments, processor unit 215 may store the image position data of the segmented produce object, for example, in database 245. The stored image position data may be used for one or more applications including, for example, data analysis and reporting, retraining the segmentation model, etc.

At act 315, processor unit 215 may determine a 3D position of a produce object segmented at act 310. Processor unit 215 may use ray casting module 265 to determine the 3D position by ray casting from an image position of the segmented produce object to a 3D mesh.

The 3D mesh may be generated by the mobile device based on relative position data of the mobile device with reference to the produce object. The 3D mesh may be generated by the mobile device using any suitable SLAM algorithm while capturing the images. The SLAM algorithm may be implemented using image data and associated depth data (e.g., LiDAR data) captured by the mobile device. The mobile device may generate a real-time 3D mesh while capturing images of the produce objects. Ray casting module 265 can enable processor unit 215 to utilize the 3D mesh and determine real-world 3D position coordinates (using any suitable reference coordinate system) corresponding to a position within the 2D captured image. In some embodiments, the mobile device may be an iPhone® or iPad® device and processor unit 215 may utilize the ARKit provided by the mobile device to determine the 3D position. In other embodiments, the mobile device may be a different device that provides the 3D mesh functionality.

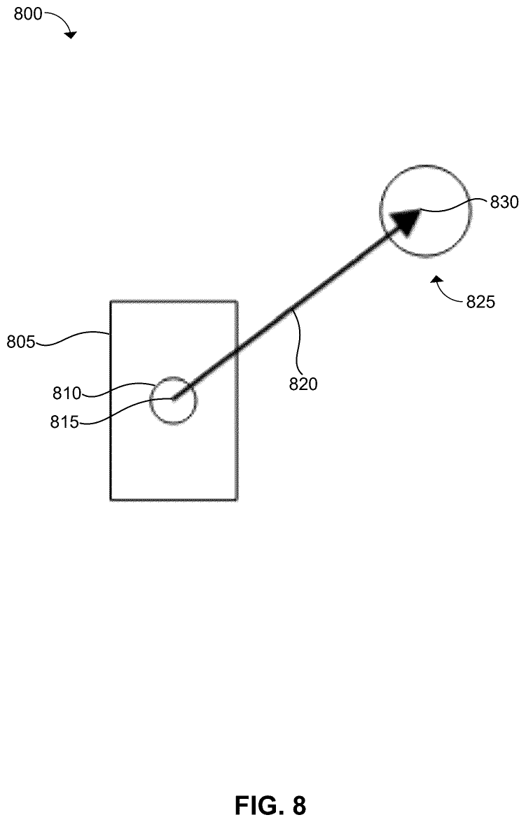

Referring now to FIG. 8, shown therein is a schematic diagram 800 of ray casting from an image position 815 associated with a segmented produce object 810 included in a captured image 805. Diagram 800 illustrates ray casting a ray 820 from image position 815 to a 3D mesh 825 to determine corresponding 3D position 830. The orientation of ray 820 may be based on an imaging angle associated with captured image 805. Any suitable image position 815 associated with segmented produce object 810 may be selected for ray casting. In some embodiments, a center of segmented produce object 810 may be selected as image position 815. In other embodiments, a different image position associated with segmented produce object 810 may be selected as image position 815.

Referring back to FIG. 3, at act 320, processor unit 215 may determine if all segmented produce objects in a received image are processed. If additional segmented produce objects need to be processed, method 300 can proceed to act 315 to determine the 3D position of the next segmented produce object. If all the segmented produce objects in a received image are processed, method 300 can proceed to act 325.

At act 325, processor unit 215 may determine if all received images are processed. If additional images need to be processed, method 300 can proceed to act 310 to segment produce objects in the next received image. If all received images are processed, method 300 can proceed to act 330.

At act 330, processor unit 215 may generate an assessment output. In some embodiments, method 300 may be executed locally (e.g., on system 100a) to provide a real-time assessment output. The assessment output may include a count of the total number of agricultural produce objects included in the captured images and/or a measured size of the agricultural produce objects.

In some embodiments, method 300 may be optimized for local execution on a mobile device to provide real-time assessment outputs. For example, method 300 can reduce computational complexity and computation resource requirements by utilizing ray casting to the 3D mesh and not requiring photogrammetry and/or parallax computations. Method 300 may utilize AI models that are optimized for execution on mobile devices and avoid usage of higher complexity occlusion-based models.

Processor unit 215 may generate the assessment output by tracking segmented produce objects in the received images based on corresponding 3D positions. For example, a series of captured images may include multiple segmented instances of the same agricultural produce object. However, the position of the multiple segmented instances may be different in different images. For example, segmented fruit 120b may be present in three received images captured using three different imaging angles of tree 116a. The position of segmented fruit 120b within the three images may be different because of the different imaging angles. However, processor unit 215 can determine identical 3D positions for the multiple instances indicating that they correspond to the same produce object and so avoid counting multiple instances of the same fruit if a fruit having the same position has already been counted in an image that has been analyzed. Processor unit 215 can use this determination to avoid duplicate assessment. For example, processor unit 215 can avoid duplicate counting of the same fruit 120b captured in three different images. Instead, processor unit 215 can use the determined 3D position to identify that the same fruit 120b is captured in three different images and count fruit 120b just once. As another example, processor unit 215 can avoid duplicate assessment in determining an average size of imaged fruits. Processor unit 215 can avoid averaging error that could be caused by considering size measurements of the same fruit 120b captured in three different images as the size measurement of three different fruits. Instead, processor unit 215 can improve the accuracy of the average size assessment by identifying that the three size measurements are associated with the same fruit 120b.

In some embodiments, the assessment output may include a size determination of the imaged agricultural produce objects. Processor unit 215 may determine size by ray casting multiple rays from image coordinates associated with a segmented produce object to a corresponding 3D mesh.

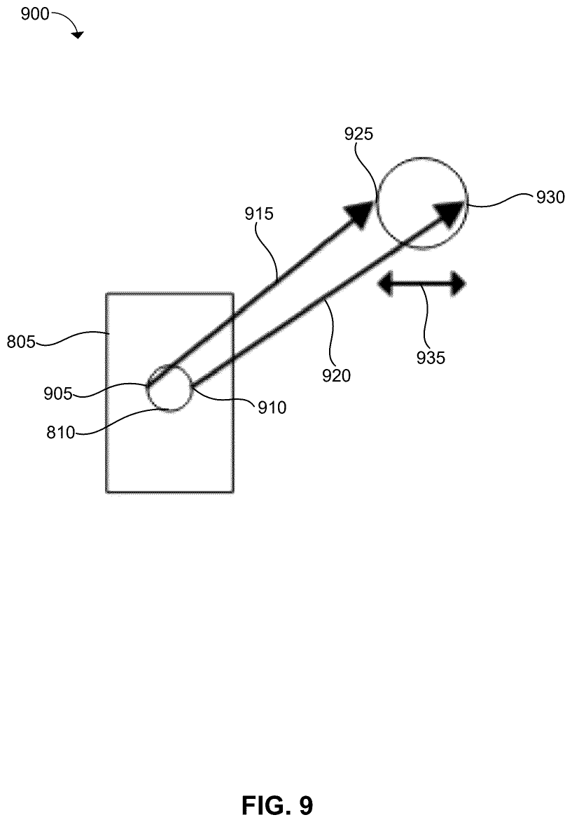

Referring now to FIG. 9, shown therein is a schematic diagram 900 illustrating size determination of a segmented produce object 810 included in a captured image 805. Rays 915 and 920 may be ray casted from image coordinates 905 and 910 respectively to determine corresponding 3D mesh positions 925 and 930. Image coordinates 905 and 910 may be any suitable coordinates based on a type of produce object and/or size determination. For example, image coordinates 905 and 910 may be diametrically opposite coordinates associated with the segmented produce object. In other embodiments, processor unit 215 may utilize different image coordinates. In the illustrated embodiment, 3D mesh positions 925 and 930 enable determination of a linear size 935. In some embodiments, processor unit 215 may utilize a greater number of rays for the size determination. For example, processor unit 215 may utilize additional linear size determinations to determine a 3D volume for the produce object. For an exemplary spherical produce object, the 3D volume may be determined based on a diameter measurement of the produce object. As another example, for an ovoid produce object, the 3D volume may be determined based on three axis measurements of the produce object.

The received images may include produce objects imaged in different orientations. For example, image 500 includes fruits 120d-120f that are each oriented in a different direction. Inconsistent assessment outputs may be generated if the size determination for each of fruits 120d-120f is made along a fixed image orientation (e.g., parallel to a horizontal image axis).

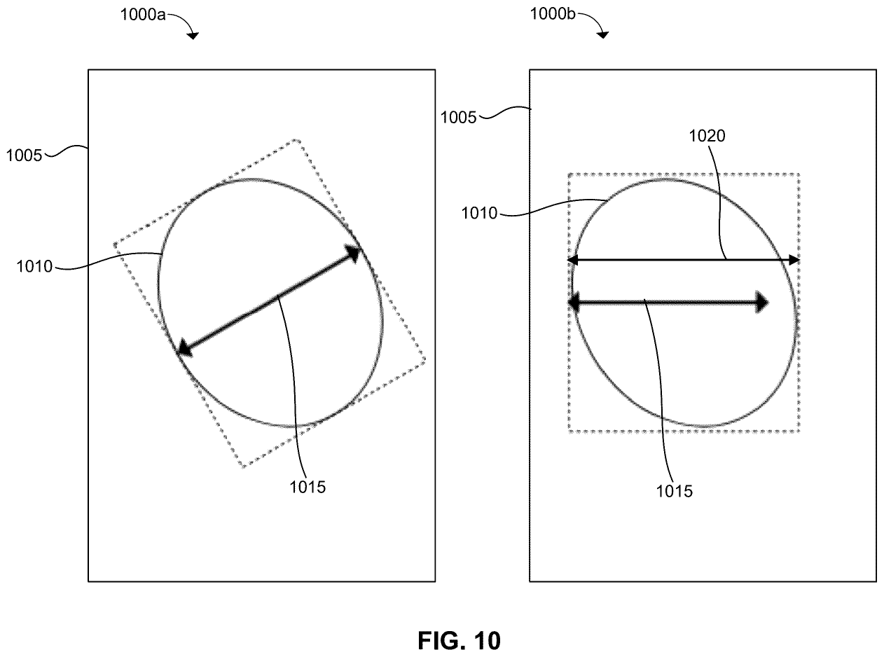

Referring now to FIG. 10, shown therein are schematic diagrams 1000a and 1000b illustrating size determination of a segmented produce object 1010 included in a captured image 1005. Schematic diagram 1000a shows a desired size measurement 1015 that may be defined as a diameter of the widest portion of the narrow side of produce object 1010. The desired size measurement criteria may be different in other examples. Schematic diagram 1000b shows an incorrect size measurement 1020 that is parallel to the horizontal image axis and does not take into consideration the orientation of segmented produce object 1010 within captured image 1005.

In some embodiments, processor unit 215 may determine an orientation of each segmented produce object and further select the image coordinates for ray casting/size determination based on the determined orientation of the segmented produce object. For the above-described example of measuring the diameter of the widest portion of the narrow side of produce object 1010, processor unit 215 may determine a top end (e.g., a stem) and a bottom end (e.g., a calyx) and measure the widest part perpendicular to a line connecting the top end and the bottom end. This can enable processor unit 215 to generate assessment outputs that include consistent size determination for the imaged produce objects.

Processor unit 215 may use any suitable method to determine the orientation of the segmented produce objects. In some embodiments, processor unit 215 may use one or more AI models to determine keypoints and/or define a rotated bounding box indicating an orientation of the segmented produce object. The AI models may include a pose model that is implemented based, for example, on a MMPose model, a DeepPoseKit toolkit or an integrated pose model. The pose model may be generated, for example, by model generation module 255. The pose model may be trained by model training module 260. For example, the pose model may be trained to determine keypoints corresponding to a stem or a calyx of an agricultural produce object.

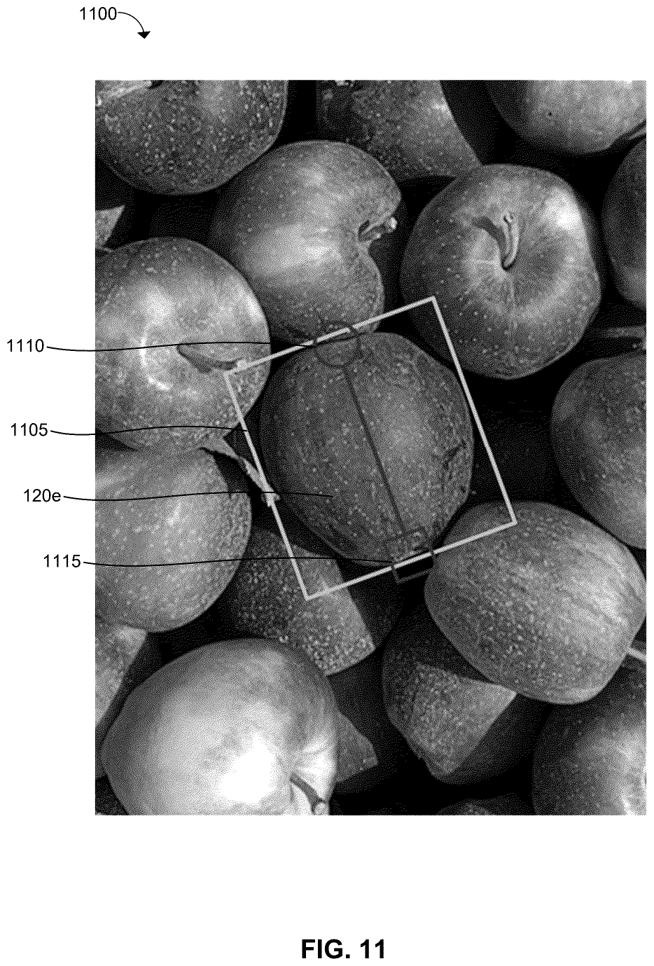

Referring now to FIG. 11, shown therein is a portion 1100 of an example captured image that includes a fruit 120e. Processor unit 215 may determine keypoints 1110 and 1115 indicating a top end and a bottom end of fruit 120e. Alternatively or in addition, processor unit 215 may determine a rotated bounding box 1105 whose rotated position indicates the orientation of imaged fruit 120e.

In some cases, a produce object may be captured in multiple received images. Processor unit 215 may make a size determination for each instance of the segmented produce object. Processor unit 215 may generate the assessment output based on the multiple size measurements to provide a higher-accuracy size determination. Processor unit 215 may generate the assessment output, for example, based on a statistical mean of the multiple size measurements or other statistical measure.

Referring back to FIG. 3, the assessment output generated at act 330 may be provided to a user via a graphical user interface (GUI). For example, user interface module 250 (shown in FIG. 2) may generate a GUI that provides count and/or size information of assessed produce objects.

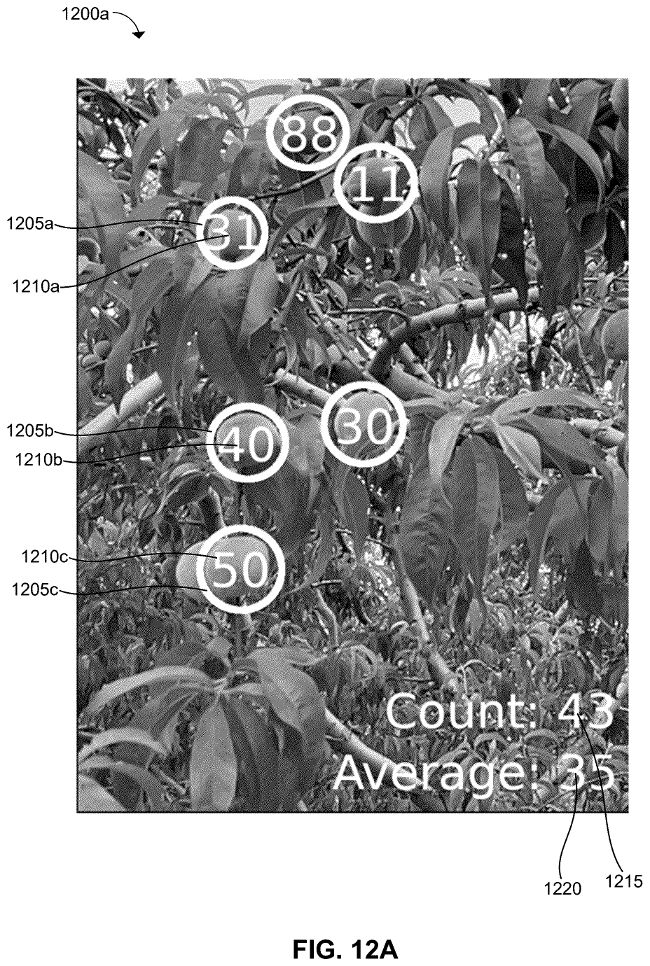

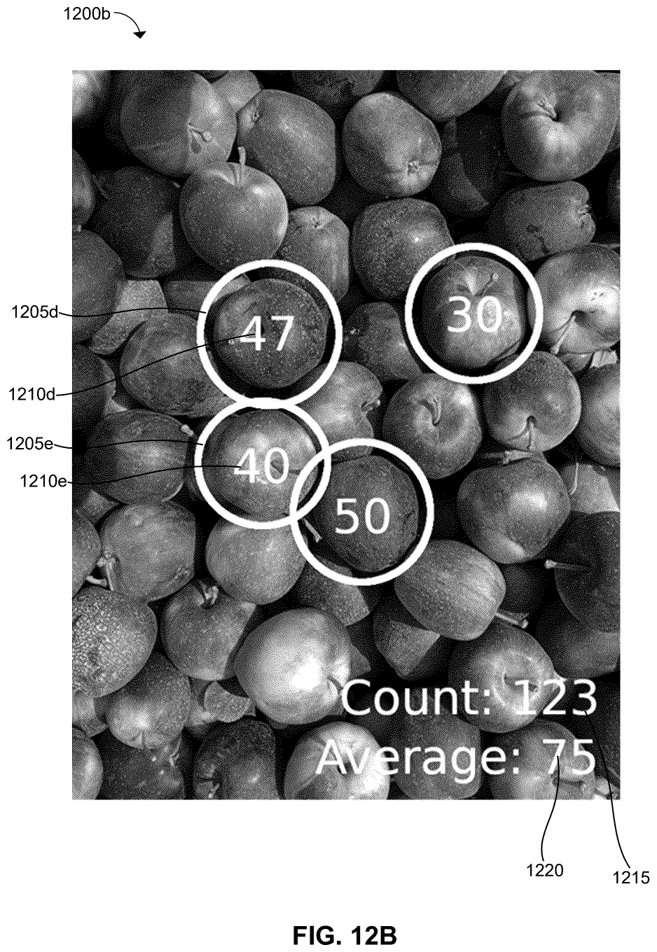

Referring now to FIGS. 12A and 12B, shown therein are example GUIs 1200a and 1200b generated based on captured images 400 and 500 respectively, and the associated depth data. Circular annotations 1205 may indicate detected produce objects and numerals 1210 may indicate determined size of associated produce objects. GUIs 1200 may further include a total count 1215 and an average size 1220 of the produce objects. Total count 1215 and average size 1220 may indicate the count and average size respectively of the detected produce objects in the captured image. In some embodiments, a series of images may be captured and total count 1215 and average size 1220 may indicate the count and average size respectively of the detected produce objects for the combined series of captured images.

Referring back to FIG. 3, the processor unit may be configured to provide a user prompt to capture additional images in response to an occlusion detection of an imaged produce object. For example, at act 325, after all captured images are processed, processor unit 215 may detect occlusion for at least one imaged produce object. The occlusion may prevent processor unit 215 from determining a size of the produce object.

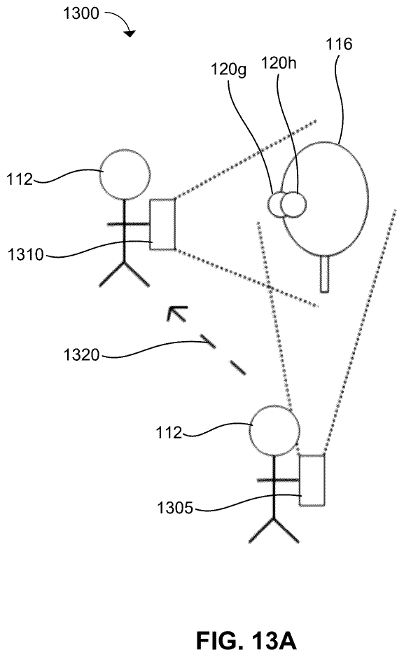

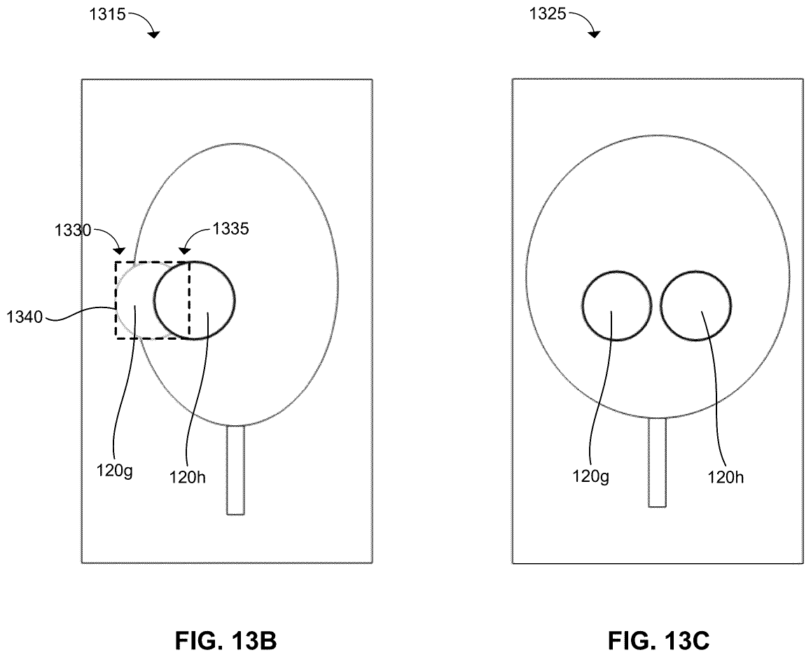

Reference is now made to FIGS. 13A, 13B and 13C. FIG. 13A shows an example schematic diagram 1300 illustrating a user 112 capturing images of fruits 120 of a tree 116. FIG. 13B shows a schematic diagram 1315 of an example image that may be captured by user 112 from an initial imaging position 1305. As illustrated in schematic diagram 1315, fruit 120g may be occluded by fruit 120h in the captured image. The occlusion may prevent processor unit 215 from making a sufficiently accurate size determination of fruit 120g.

In response to the occlusion detection, processor unit 215 may generate a user prompt 1320 to move to a new imaging position 1310. Processor unit 215 may use any suitable combination of graphical and textual elements to provide user prompt 1320. In some embodiments, processor unit 215 may provide user prompt 1320 using an augmented reality (AR) display.

Processor unit 215 may use any suitable method to determine the new imaging position 1310. For example, processor unit 215 may first determine the 3D position associated with fruit 120g. Further, processor unit 215 may conduct ray tracing from the determined 3D position to determine ray traces that are unobstructed by fruit 120h. For example, a bounding box 1340 defined for fruit 120g may include a portion of fruit 120 h that is occluding fruit 120g. A ray cast from the imaging device position to occluded portion 1335 may be closer compared with a ray cast to non-occluded portion 1330. Processor unit 215 may make an occlusion detection when a difference between the two rays is larger compared with a maximum size range of fruit 120g. In the illustrated example, fruit 120g is occluded by fruit 120h. In other examples, fruit 120g may be occluded by any other object (e.g., a different portion of the tree, for example, a branch or a leaf or an unrelated object present in the environment, for example, a bird). Processor unit 215 may determine new imaging position 1310 based on the unobstructed ray traces and an optimum distance (e.g., shortest distance) from initial imaging position 1305.

FIG. 13C shows a schematic diagram 1325 of an example image that may be captured by user 112 from new imaging position 1310. As illustrated in schematic diagram 1325, fruit 120g is not occluded by fruit 120h in the captured image. Processor unit 215 may use this captured image to make a sufficiently accurate size determination of fruit 120g.

Various actions can be performed based on the assessments performed by the embodiments described herein. For example, reports may be generated that include the assessment of the fruits on each tree a count of fruit and/or a size of each fruit. Reports may additionally or alternatively include information on the average assessment of all of the trees assessed where the average assessment may include an average count of fruit per tree and/or an average size of each fruit. The assessment output may include information related to color of produce objects, density of produce objects (placement versus size of scan), balance of produce objects throughout a canopy, location of the produce objects on an assessed tree/shrub/vine (e.g., determined by measuring object distance from a bottom of the 3D mesh), count of clusters/bunches of produce objects, and/or shape of produce objects. The assessment information may then be used to decide whether to perform any actions on the trees such as whether any treatments are needed for the trees to improve the growth of the fruits and/or harvesting the fruit of one or more trees if the assessed fruit indicate that they are ready for harvest.

Alternatively, the embodiments described herein may be used to perform assessment of harvested fruit where the harvest fruit may be in containers, or laid out over a surface such as a table, the ground or a conveyor belt. In such embodiments, actions performed based on the fruit assessment may be to sort the fruit into different containers, and/or discarding fruit that is too small. The assessment information may include information related to size, shape, color, and/or surface defects of produce objects. For an example assessment of produce objects laid out over a conveyor belt, the assessment information may include harvest speed information based on the produce object assessments and speed/timing information of the conveyor belt.

Although embodiments have been described above with reference to the accompanying drawings, those of skill in the art will appreciate that variations and modifications may be made. For example, while the agricultural produce assessments have been described using fruits as an example, the agricultural produce assessments may be performed for other agricultural produce including vegetables.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. An agricultural produce assessment system comprising:
a memory configured to store one or more AI models; and
a processor coupled to the memory and configured to:
receive one or more images captured by a mobile device;
segment at least one produce object in the one or more images using the one or more AI models;
determine a 3D position of the at least one produce object by ray casting from an image position of the at least one produce object to a 3D mesh, wherein the 3D mesh is generated by the mobile device based on relative position data of the mobile device with reference to the at least one produce object; and
generate an assessment output by tracking the at least one produce object in the one or more images based on the determined 3D position.

2. The agricultural produce assessment system of claim 1, wherein the relative position data is generated by a Light Detection and Ranging (LiDAR) sensor of the mobile device.

3. The agricultural produce assessment system of claim 1, wherein the processor is configured to generate the assessment output by determining a size of the at least one produce object.

4. The agricultural produce assessment system of claim 1, wherein a plurality of images captured by the mobile device include the at least one produce object, and the processor is configured to determine the size of the at least one produce object based on multiple size measurements of the at least one produce object using two or more of the plurality of images.

5. The agricultural produce assessment system of claim 3, wherein the processor is configured to determine the size by ray casting two or more rays from image coordinates associated with the at least one produce object to the 3D mesh.

6. The agricultural produce assessment system of claim 5, wherein determining the image coordinates comprises:
using the one or more AI models to determine keypoints indicating an orientation of the at least one produce object; and/or using the one or more AI models to define a bounding box indicating the orientation of the at least one produce object.

7. The agricultural produce assessment system of claim 6, wherein the at least one produce object is a fruit and the determined keypoints include keypoints corresponding to a stem or a calyx of the fruit.

8. The agricultural produce assessment system of claim 1, wherein the mobile device comprises the processor and the processor is configured to generate the assessment output in real-time and locally on the mobile device.

9. The agricultural produce assessment system of claim 8, wherein the processor is further configured to provide a user prompt to capture additional images in response to an occlusion detection of the at least one produce object.

10. The agricultural produce assessment system of claim 1, wherein a remote server comprises the processor and the remote server is communicatively coupled with the mobile device.

11. The agricultural produce assessment system of claim 1, wherein the agricultural produce assessment is for pre-harvested fruits and/or pre-harvested vegetables.

12. The agricultural produce assessment system of claim 1, wherein the agricultural produce assessment is for harvested fruits and/or harvested vegetables.

13. The agricultural produce assessment system of claim 1, wherein the processor is configured to segment the at least one produce object by inputting, into the one or more AI models, metadata associated with the one or more images.

14. The agricultural produce assessment system of claim 13, wherein the metadata includes image resolution, lighting conditions, and/or context information for the one or more images.

15. A computer-implemented method of agricultural produce assessment, the method comprising:
receiving, by a processor, one or more images captured by a mobile device;
segmenting, by the processor, at least one produce object in the one or more images using the one or more AI models;
determining, by the processor, a 3D position of the at least one produce object by ray casting from an image position of the at least one produce object to a 3D mesh, wherein the 3D mesh is generated by the mobile device based on relative position data of the mobile device with reference to the at least one produce object; and
generating, by the processor, an assessment output by tracking the at least one produce object in the one or more images based on the determined 3D
position.

16. The method of claim 15, wherein the relative position data is generated by a Light Detection and Ranging (LiDAR) sensor of the mobile device.

17. The method of claim 15, wherein the method comprises generating the assessment output by determining a size of the at least one produce object.

18. The method of claim 15, wherein a plurality of images captured by the mobile device include the at least one produce object, and the method further comprises the processor determining the size of the at least one produce object based on multiple size measurements of the at least one produce object using two or more of the plurality of images.

19. The method of claim 17, wherein the method comprises the processor determining the size by ray casting two or more rays from image coordinates associated with the at least one produce object to the 3D mesh.

20. The method of claim 19, wherein determining the image coordinates comprises:
using the one or more AI models to determine keypoints indicating an orientation of the at least one produce object; and/or using the one or more AI models to define a bounding box indicating the orientation of the at least one produce object.

21. The method of claim 20, wherein the at least one produce object is a fruit and the determined keypoints include keypoints corresponding to a stem or a calyx of the fruit.

22. The method of claim 15, wherein the mobile device comprises the processor and the method comprises the processor generating the assessment output in real-time and locally on the mobile device.

23. The method of claim 22, wherein the method further comprises the processor providing a user prompt to capture additional images in response to an occlusion detection of the at least one produce object.

24. The method of claim 15, wherein a remote server comprises the processor and the remote server is communicatively coupled with the mobile device.

25. The method of claim 15, wherein the agricultural produce assessment is for pre-harvested fruits and/or pre-harvested vegetables.

26. The method of claim 15, wherein the agricultural produce assessment is for harvested fruits and/or harvested vegetables.

27. The method of claim 15, wherein the method comprises the processor segmenting the at least one produce object by inputting, into the one or more AI models, metadata associated with the one or more images.

28. The method claim 27, wherein the metadata includes image resolution, lighting conditions, and/or context information for the one or more images.

29. A non-transitory computer readable medium storing thereon program instructions, which when executed by at least one processor, configure the at least one processor to perform a method of agricultural produce assessment, the method comprising:
receiving, by a processor, one or more images captured by a mobile device;
segmenting, by the processor, at least one produce object in the one or more images using the one or more AI models;
determining, by the processor, a 3D position of the at least one produce object by ray casting from an image position of the at least one produce object to a 3D mesh, wherein the 3D mesh is generated by the mobile device based on relative position data of the mobile device with reference to the at least one produce object; and
generating, by the processor, an assessment output by tracking the at least one produce object in the one or more images based on the determined 3D position.
